(19) United States
(12) Patent Application Publication
(10) Pub. No.: US 2023/0331607 A1
(43) Pub. Date: Oct. 19, 2023

(54) STORM FLOW OPERATION AND SIMULTANEOUS NITRIFICATION DENITRIFICATION OPERATION IN A SEQUENCING BATCH REACTOR

(71) Applicant: Evoqua Water Technologies LLC, Pittsburgh, PA (US)

(72) Inventor: NICHOLAS A. BARCZEWSKI, Waukesha, WI (US)

(73) Assignee: Evoqua Water Technologies LLC, Pittsburgh, PA (US)

(21) Appl. No.: 18/026,821

(22) PCT Filed: Sep. 16, 2021
(86) PCT No.: PCT/US21/50570

§ 371 Date: Mar. 16, 2023

Related U.S. Application Data
(60) Provisional application No. 63/078,985, filed on Sep. 16, 2020.

(51) Int. Cl. C02F 3/30

(52) U.S. Cl. CPC C02F 3/302; C02F 2209/08; C02F 2209/40; C02F 2209/22; C02F 2209/006; C02F 2103/001

(57) ABSTRACT

Methods of treating wastewater with a sequencing batch reactor (SBR) system having a plurality of SBRs are disclosed. The methods include operating each of the reactors in a batch flow mode, which includes controlling dissolved oxygen in the reactor to a concentration insufficient to meet a biological oxygen demand of the wastewater, but sufficient to cause simultaneous nitrification and denitrification reactions. The methods include determining an anticipated flow rate, selecting one or more reactor(s) capable of receiving wastewater in a continuous flow mode, and responsive to the anticipated flow rate being greater than one tolerated by the reactors, operating the selected reactor(s) in a continuous flow mode. Sequencing batch reactor systems including a plurality of SBRs, each having an aerator, a loading subsystem, and a controller are also disclosed.

### CROSS-REFERENCE TO RELATED APPLICATIONS

This application claims the benefit under 35 U.S.C. § 119 of U.S. Patent Application No. 63/078,985, titled “Combining Superior Storm Flow Operation and Efficient SNDN Operation into an SBR Application,” filed on Sep. 16, 2020, which is incorporated herein by reference in its entirety for all purposes.

### FIELD OF TECHNOLOGY

Aspects and embodiments disclosed herein are directed toward systems and methods for the treatment of wastewater in a sequencing batch reactor.

### SUMMARY

In accordance with one aspect, there is provided a method of treating wastewater with a sequencing batch reactor system having a plurality of reactors arranged in parallel. The method may comprise operating each of the reactors in a batch flow mode. The batch flow mode may comprise introducing a wastewater to be treated into one reactor to produce a first mixed liquor and controlling a dissolved oxygen concentration of the first mixed liquor to a predetermined concentration insufficient to meet a biological oxygen demand of the wastewater to be treated, but sufficient to cause simultaneous nitrification and denitrification reactions to occur in the first mixed liquor, producing a first treated water and a first solids. The method may comprise determining an anticipated flow rate of the wastewater to be treated at an inlet of the sequencing batch reactor system. The method may comprise selecting one or more reactor as being in a state capable of receiving the wastewater to be treated in a continuous flow mode. The method may comprise, responsive to the anticipated flow rate having been determined to be greater than a flow rate tolerated by a design hydraulic loading rate of each of the reactors, operating the one or more selected reactor in the continuous flow mode. The continuous flow mode may comprise simultaneously introducing the wastewater to be treated into the one or more selected reactor to produce a second mixed liquor, aerating the second mixed liquor to produce a second treated water and a second solids, settling the second solids, and decanting the second treated water.

In some embodiments, the batch flow mode may further comprise sequentially settling the first solids and decanting the first treated water.

In some embodiments, the batch flow mode may comprise a first treatment regime comprising controlling the dissolved oxygen concentration to a first predetermined concentration, a second treatment regime comprising controlling the dissolved oxygen concentration to a second predetermined concentration performed immediately following the first treatment regime, and a third treatment regime comprising controlling the dissolved oxygen concentration to a third predetermined concentration performed immediately following the second treatment regime. In some embodiments, the first predetermined concentration and the second predetermined concentration are insufficient to meet the biological oxygen demand of the wastewater to be treated, but sufficient to cause simultaneous nitrification and denitrification reactions to occur in the first mixed liquor. In some embodiments, the third predetermined concentration is sufficient to meet the biological oxygen demand of the wastewater to be treated.

In some embodiments, the method may comprise selecting the one or more reactor based on a current cycle period being one of the first treatment regime, the second treatment regime, decanting, and idle.

In some embodiments, the continuous flow mode is associated with a hydraulic loading rate of about 25% to about 50% of a hydraulic loading rate associated with the batch flow mode.

In some embodiments, the method may further comprise measuring at least one reactor parameter for each of the reactors selected from available fill volume, composition of the wastewater to be treated, composition of the first mixed liquor, and hydraulic loading rate.

The method may comprise selecting the one or more reactor responsive to the at least one measured reactor parameter.

The method may further comprise determining at least one flow rate parameter selected from expected precipitation, actual precipitation, expected sewerage flow rate, and actual sewerage flow rate.

The method may further comprise determining the anticipated flow rate responsive to the at least one flow rate parameter.

In some embodiments, the expected precipitation is determined responsive to at least one of a predicted weather event, time of day, time of year, and geographic location.

In some embodiments, the expected sewerage flow rate is determined responsive to at least one of a predicted sewerage event, time of day, time of year, and geographic location.

In some embodiments, the method may comprise responsive to the anticipated flow rate having been determined to be within a flow rate tolerated by a design hydraulic loading rate of each of the reactors, continuing operation of the one or more selected reactor in the batch flow mode. The method may comprise re-evaluating the anticipated flow rate of the wastewater to be treated at the inlet of the sequencing batch reactor system after a period of time.

The method may further comprise measuring at least one of dissolved oxygen, oxidation reduction potential, and concentration of a nitrogen compound selected from molecular nitrogen (dinitrogen, N₂) gas, nitrate, nitrite, and/or ammonia of the first mixed liquor or the second mixed liquor.

In some embodiments, the predetermined concentration of dissolved oxygen is between about 0.05 mg/L and about 0.8 mg/L.

In some embodiments, after operating the one or more reactor in the continuous flow mode, the method may further comprise determining a subsequent anticipated flow rate of the wastewater to be treated at the inlet of the sequencing batch reactor system. The method may further comprise, responsive to the subsequent anticipated flow rate having been determined to be within the flow rate tolerated by the design hydraulic loading rate of each of the reactors, operating the one or more selected reactor in the batch flow mode.

In some embodiments, the method further comprises a transition period comprising settling an effective amount of the solids at an outset of the continuous flow mode.

In some embodiments, the anticipated flow rate is a flow rate expected after an amount of time of the transition period.

In accordance with another aspect, there is provided a sequencing batch reactor system. The system may comprise a plurality of sequencing batch reactors arranged in parallel, each of the reactors having an inlet fluidly connectable to a source of wastewater to be treated and an outlet. In some embodiments, each of the reactors may comprise an aerator configured to deliver an oxygen-containing gas to a mixed liquor within a corresponding reactor. The system may comprise a loading subsystem configured to independently control a hydraulic loading rate of the wastewater to be treated into each of the reactors through the inlet. In some embodiments, the system may comprise a controller operably connected to the aerator of each of the reactors and the loading subsystem. The controller may be configured to transmit a first output signal to the aerator of each of the reactors to control the dissolved oxygen concentration of the mixed liquor within the reactor to a predetermined concentration insufficient to meet a biological oxygen demand of the wastewater to be treated, but sufficient to cause simultaneous nitrification and denitrification reactions to occur in the mixed liquor, producing a treated water and a solids. The controller may be configured to transmit a second output signal to the loading subsystem to introduce the wastewater to be treated into one or more reactors in a continuous flow mode, responsive to the one or more reactor being in a state capable of receiving the wastewater to be treated in the continuous flow mode, and determining an anticipated flow rate of the wastewater to be treated at an inlet of the sequencing batch reactor system to be greater than a flow rate tolerated by a design hydraulic loading rate of each of the reactors.

The system may further comprise a sensing subsystem operably connected to the controller and configured to measure at least one parameter associated with a concentration of dissolved oxygen in at least one of the mixed liquor within each of the reactors and the wastewater to be treated and transmit a first input signal to the controller corresponding to the measured dissolved oxygen parameter.

The controller may be configured to transmit the first output signal responsive to the first input signal.

The sensing subsystem may be configured to measure at least one of dissolved oxygen concentration, oxidation reduction potential, and concentration of a nitrogen compound selected from molecular nitrogen (dinitrogen, N₂) gas, nitrate, nitrite, and/or ammonia of the mixed liquor and/or the wastewater to be treated.

In some embodiments, the system may further comprise a measuring subsystem operably connected to the controller and configured to measure at least one parameter associated with the state of each of the reactors and transmit a second input signal to the controller corresponding to the at least one measured reactor parameter.

The controller may be configured to transmit the second output signal responsive to the second input signal.

In some embodiments, the measuring subsystem may be configured to measure at least one of available fill volume, composition of the wastewater to be treated, composition of the mixed liquor, and hydraulic loading rate of each of the reactors.

The controller may be configured to receive a third input signal corresponding to at least one anticipated flow rate parameter selected from expected precipitation, actual precipitation, expected sewerage flow rate, and actual sewerage flow rate and transmit the second output signal responsive to the third input signal.

In some embodiments, the controller may be programmable to recognize trends of the anticipated flow rate on a schedule and transmit the second output signal responsive to the recognized trends.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates steps typically performed in a conventional sequencing batch reactor;

FIG. 2 illustrates forms of treatment performed in different steps in a conventional sequencing batch reactor;

FIG. 3 illustrates the concept of operating a wastewater treatment system an at an oxygen deficit suitable for performing simultaneous nitrification/denitrification;

FIG. 4 illustrates typical ORP conditions used in wastewater treatment;

FIG. 5 is a simplified schematic diagram of a sequencing batch reactor, according to one embodiment;

FIG. 6 is a top plan view of a wastewater treatment system, according to one embodiment;

FIG. 7 is a partial top plan view of a wastewater treatment system, according to one embodiment;

FIG. 8 is a partial cross-sectional side view of a wastewater treatment system, according to one embodiment;

FIG. 9 is flowchart showing of a control scheme which can be implemented by a controller, according to one embodiment; and

FIG. 10 is a box diagram of a sequencing batch reactor system, according to one embodiment.

### DETAILED DESCRIPTION

Methods for treating wastewater generated from industrial and municipal sources include biological, physical, and/or chemical processes. For instance, biological treatment of wastewater may include aerobic, anoxic, and/or anaerobic treatment units to reduce the total organic content and/or biochemical oxygen demand of the wastewater. Wastewater treatment may be performed as a continuous process or in batch mode. One form of batch mode of wastewater treatment utilizes a sequencing batch reactor.

Wastewater treatment systems use various processes for treating wastewater generated from municipal and industrial sources. Wastewater treatment typically includes three general phases. The first phase, or primary treatment, may involve mechanically separating dense solids from less dense solids and liquids in the wastewater. Primary treatment is typically performed in sedimentation tanks using gravity separation. The second phase, or secondary treatment, may involve biological conversion of ammonia and carbonaceous and nutrient material in the wastewater to more environmentally friendly forms. Secondary treatment is typically performed by promoting the consumption of the ammonia and carbonaceous and nutrient material by bacteria and other types of beneficial organisms already present in the wastewater or that are mixed into the wastewater. The third phase, or tertiary treatment, may involve removing the remaining pollutant material from the wastewater. Tertiary treatment is typically performed by filtration or sedimentation with the optional addition of chemicals, UV light, and/or ozone to neutralize harmful organisms and remove any remaining pollutant material.

Moreover, digestion may be under aerobic conditions wherein the biomass and the wastewater liquid mixes with oxygen. Alternatively, digestion may be under “anoxic” or anaerobic conditions, where no oxygen or air is added to the reactor. The latter is used to facilitate biodegradation of nitrogen containing compounds, such as nitrates.

Secondary treatment of wastewater may be performed in a continuous flow process or in a batch process, for example, in a sequencing batch reactor. Sequencing batch reactors (SBR) or sequential batch reactors are a type of activated sludge process for the treatment of wastewater. An SBR typically performs a type of activated sludge process for the treatment of water/wastewater in a single basin or vessel. SBRs may generally handle a wide range of wastewater flows (for example, 25,000 gpd-100 MGD). SBR reactors typically treat wastewater such as sewage or output from anaerobic digesters or mechanical biological treatment facilities in batches. In such treatment, oxygen may be bubbled through the mixture of wastewater and activated sludge to reduce the organic matter (measured as biochemical oxygen demand (BOD) and chemical oxygen demand (COD)). The treated effluent may be suitable for discharge to surface waters or possibly for use on land.

While there are several configurations of SBRs, the basic process is similar across different configurations. The SBR installation typically includes one or more tanks that can be operated as plug flow or completely mixed reactors. The tanks may have a “flow through” system, with raw wastewater (influent) coming in at one end and treated water (effluent) flowing out the other end. In systems with multiple tanks, while one tank is in settle/decant mode another may be aerating and filling. In some systems, tanks contain a section known as the bio-selector, which may include a series of walls or baffles which direct the flow either from side to side of the tank or under and over consecutive baffles. This flow may help to mix the incoming influent and the returned activated sludge (RAS), beginning the biological digestion process before the liquor enters the main part of the tank.

In operation, the SBR treatment systems disclosed herein typically decontaminate the influent wastewater in a treatment cycle including series of steps or periods. These treatment steps may vary according a number of factors including, for example, influent flow rate, pollutant concentration and type, biomass concentration and diversity or type, ambient temperature, air flow, number of available reactors and other conditions such as downstream capacity and availability.

As used herein, “influent” defines a stream of “wastewater,” from a municipal or industrial source, having pollutants or “biodegradable material,” inorganic or organic compounds capable of being decomposed by bacteria, flowing into the wastewater treatment system. A “wastewater treatment apparatus” is a system, typically a biological treatment system, having a “biomass,” a population of bacterial microorganisms or a diversity of types of bacteria, used to digest biodegradable material. Notably, the biomass requires an environment that provides the proper conditions for growth including nutrients.

“Digestion” refers to the biodegradation process where the biomass consumes the biodegradable material and reduces the biodegradable material to solid material which can be flocculated and removed by gravity sedimentation or settling into sludge. For example, in the biodegradation process, bacteria may use enzymes to hydrolyze or breakdown complex organic compounds, such as carbohydrates, into simple organic molecules, like carbon dioxide and water. During digestion, the bacteria may also reproduce which results in additional biomass. The settling process may also produce a substantially clear liquid layer above the settled sludge layer. Notably, the sludge may contain digested inorganic and organic materials and biomass.

A typical SBR operates five stages of a treatment process, including fill, react, settle, decant or draw, and idle stages. In the fill stage, an inlet valve of the SBR tank may be opened to fill the tank with wastewater to be treated. Mechanical mixing (with no air) may be performed. This stage may also be called the anoxic fill stage.

Aeration of the mixed liquor may be performed during the second stage (the react stage). Aeration may be effectuated by introducing an oxygen containing gas into the SBR, for example, by the use of fixed or floating mechanical pumps or by transferring air into fine bubble diffusers fixed to the floor of the tank. Aeration times may vary according to the plant size and the composition/quantity of the incoming liquor, but are typically between 60 to 90 minutes. The addition of oxygen to the liquor encourages the multiplication of aerobic bacteria, which consume the nutrients. The process encourages the conversion of nitrogen from its reduced ammonia form to oxidized nitrite and nitrate forms, a process known as nitrification.

To remove phosphorus compounds from the liquor, aluminum sulfate (alum) is often added during the aeration period. The alum may react to form non-soluble compounds, which settle into the sludge in the next stage.

The settling stage may be performed with no aeration or mixing. During this stage, the settling of suspended solids begins. The settling stage is usually the same length in time as the aeration stage. During the settling stage the sludge formed by the bacteria is allowed to settle to the bottom of the tank. The aerobic bacteria may continue to multiply until the dissolved oxygen is about used up. Conditions in the tank, especially near the bottom, are generally more suitable for the anaerobic bacteria to flourish during this stage. Many of the anaerobic bacteria, and some of the bacteria which would prefer an oxygen environment (aerobic bacteria), may start to use oxidized nitrogen instead of oxygen gas as an alternate terminal electron acceptor, and convert the nitrogen to a gaseous state, as nitrogen oxides or, ideally, molecular nitrogen (dinitrogen, N₂) gas. This reaction is known as denitrification. Typically, the sludge is allowed to settle until clear water is on a top target percent of the tank contents. An exemplary target percent is 20-30%.

During the decant stage, an outlet valve of the SBR tank may be opened to remove the “clean” supernatant liquor. The decant stage most commonly involves the slow lowering of a scoop or “trough” into the basin. The scoop or trough may have a piped connection to a lagoon. The final effluent may be stored in the lagoon for disposal or discharged if the effluent requirements are met.

Anoxic SBR may be used for anaerobic processes, such as the removal of ammonia via anaerobic ammonium oxidation (annamox). In such processes, the reactors are typically purged of oxygen by flushing with inert gas. Generally, no aeration accompanies this process.

As the bacteria multiply and die, the sludge within the tank increases over time. A waste activated sludge (WAS) pump may remove some of the sludge during the settle stage to a digester for further treatment. The quantity or “age” of sludge within the tank is typically closely monitored, as this can have a marked effect on the treatment process.

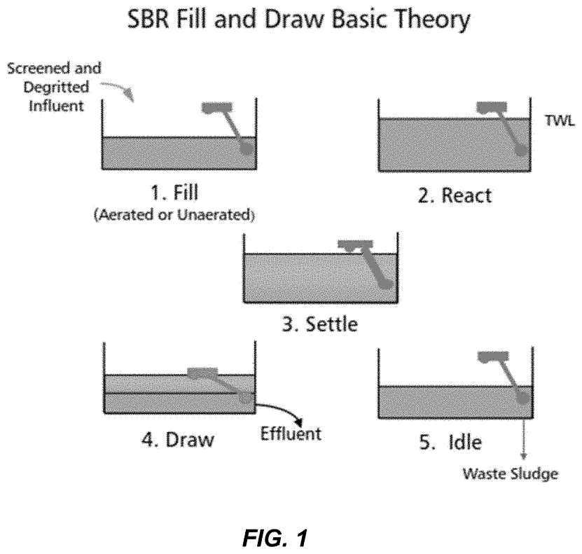

While these systems vary in nature, the typical SBR process is time or flow based. Conventionally, each of the fill, react, settle, draw or decant, and idle steps is performed independently of each other. These steps are outlined in FIG. 1.

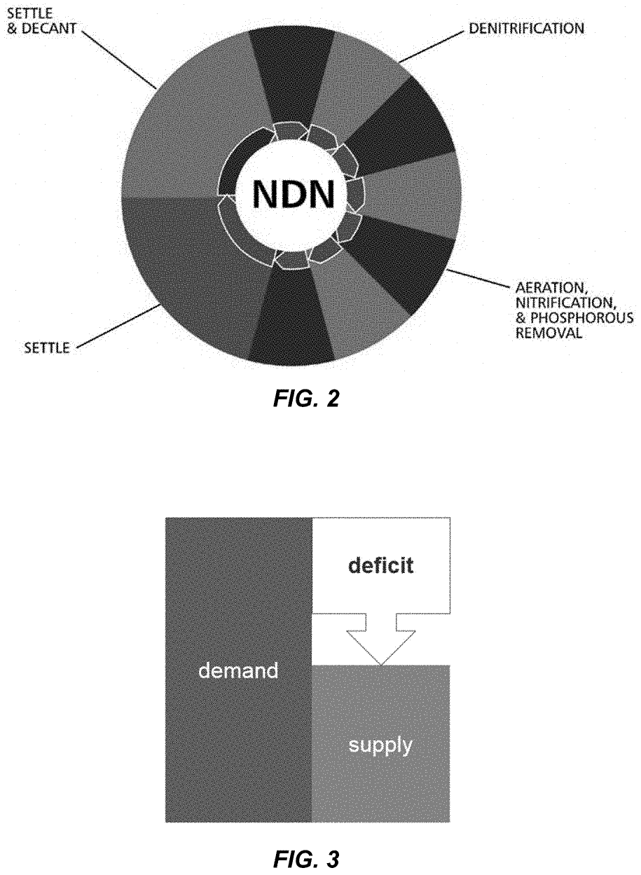

As illustrated in FIG. 2, an SBR uses distinct air on/off periods to achieve biological total nitrogen (TN) and phosphate (P) removal. During times of air on (nitrification) the dissolved oxygen (DO) set point may be about 2 mg/L. While the air is off (denitrification) the DO may be about 0 mg/L. To achieve these set points, the blowers which provide aeration may control the amount of DO in the process by ramping up and down numerous times over the course of a single day. Such operation methods may be costly from an operations standpoint.

There are currently 3,500+ sequencing batch reactors (SBRs) worldwide used to treat both municipal and industrial water/wastewater applications. With the market for SBRs growing exponentially year over year, improvements in SBR technology can have positive economic effects for companies designing and selling SBR equipment and controls. Systems and methods disclosed herein may be employed for treating waste material using an SBR or a series of SBRs. The influent may be treated by controlling the metabolic activity of the microorganisms, for example, by monitoring the oxygen utilization rate or the potential oxygen utilization rate of the biomass so as to determine the required amount of oxygen to be supplied to the biomass. In particular, metabolic activity may be controlled to provide an SBR operating a simultaneous nitrification denitrification (SNDN) biological process, which can lower energy consumption resulting in a more energy efficient process.

In accordance with certain embodiments, the systems and methods disclosed herein may relate to a wastewater treatment system having an SBR operating in SNDN, as described in U.S. Patent Application Publication No. 2020/0283315 titled “Simultaneous Nitrification/Denitrification (SNDN) in Sequencing Batch Reactor Applications,” incorporated herein by reference in its entirety for all purposes.

SNDN may be defined as operating the SBR in an oxygen deficit condition. During SNDN operation, less oxygen may be generated than the demand requires. Typically, this is between 60-75% of the oxygen demand within a given treatment system.

By utilizing a SNDN biological process, in an SBR application, it is possible to achieve both nitrification and denitrification at the same time while running at a DO of about 0 mg/L and/or oxygen reduction potential (ORP) of about −150 mV. FIG. 3 illustrates the concept of operating an SBR at an oxygen deficit, where chemical or biological oxygen demand is less than oxygen supply, suitable for performing SNDN.

Thus, an SBR under SNDN conditions may operate four stages of a treatment process, including treatment, settle, draw or decant, and idle. The treatment stage may be comprised of more than one treatment stage, for example, first, second, and third treatment stages. The stages of the treatment step may be defined by DO concentration and may include filling and/or reacting the SBR.

By operating under SNDN conditions, it is possible to skip the independent nitrification and denitrification steps, as shown in FIG. 2, which are customary to a conventional SBR process. The same effluent requirements can be achieved at a much lower DO, which lowers the energy requirement to run the treatment system. The process may generally be operated at a lower DO, except near the end of the react stage. During this stage, DO may be increased to achieve nitrification in a polishing fashion.

The first treatment stage may be a first aerated anoxic step having a target dissolved oxygen level of between 0.05 mg/L and 0.4 mg/L, for example, between about 0.1 and 0.4 mg/L, between about 0.2 and 0.4 mg/L, about 0.1 mg/L, about 0.2 mg/L, about 0.3 mg/L, or about 0.4 mg/L. The first treatment stage may be performed while the SBR is filling, for example, for a first period of a fill step. The first period of the fill step may be, for example, 70-80% of the fill step. In exemplary embodiments, the first treatment stage may be operated during the first 2.25 hours of a 3-hour fill step.

The second treatment stage may be a second aerated anoxic step immediately following the first aerated anoxic fill step. The second treatment stage may be performed with a target DO level of from 0.4 mg/L to 0.8 mg/L, for example 0.6 mg/L. The second treatment stage may be performed for a remaining period of the fill step and a first period of the react step. For example, the second treatment stage may be performed for the remaining 20-30% of the fill step. The second treatment stage may be performed for 40-60% of the react stage. In exemplary embodiments, the second treatment stage may be performed for the remaining 0.75 hours of the fill step and 0.75 hours of the react step, for a total of 1.5 hours.

The third treatment stage may be a third aerated anoxic step immediately following the second aerated anoxic fill step. The third treatment stage may be performed with a target DO level of about 2 mg/L, for example, from 1.8 mg/L to 2.2 mg/L. The third treatment stage may be performed for the remaining react stage, for example, for the remaining 40-60% of the react stage. In exemplary embodiments, the third treatment step may be performed for the remaining 0.75 hours of the react step.

Immediately following the third aerated anoxic step, a settle step may be performed. In exemplary embodiments, the settle step may be performed for about 0.75 hours. The settle step may be performed with no aeration. The settle step may be followed immediately by a decant step. In exemplary embodiments, the decant step may be performed for about 0.5 hours. The decant step may be followed immediately by an idle/wasting step. In exemplary embodiments, the idle/wasting step may be performed for 0.25 hours. Thus, a single operation cycle of the SBR may consist of the combination of the first, second, and third aerated anoxic steps, the settle step, the decant step, and the idle/wasting step.

In some embodiments an SBR performing the SNDN process may be combined with SmartBNR™ controls system (Evoqua Water Technologies LLC, Pittsburgh, PA). Aspects and embodiments disclosed herein are not limited by the type of control system.

One important device used in SBRs are diffusers for aeration. One embodiment of a type of diffuser which may be utilized in SRBs as disclosed herein is the Diamond™ S Plus Edition membrane diffuser (Evoqua Water Technologies LLC, Pittsburgh, PA). Aspects and embodiments disclosed herein are not limited by the type of diffuser used to provide an oxygen-containing gas, such as air, to the SBR system.

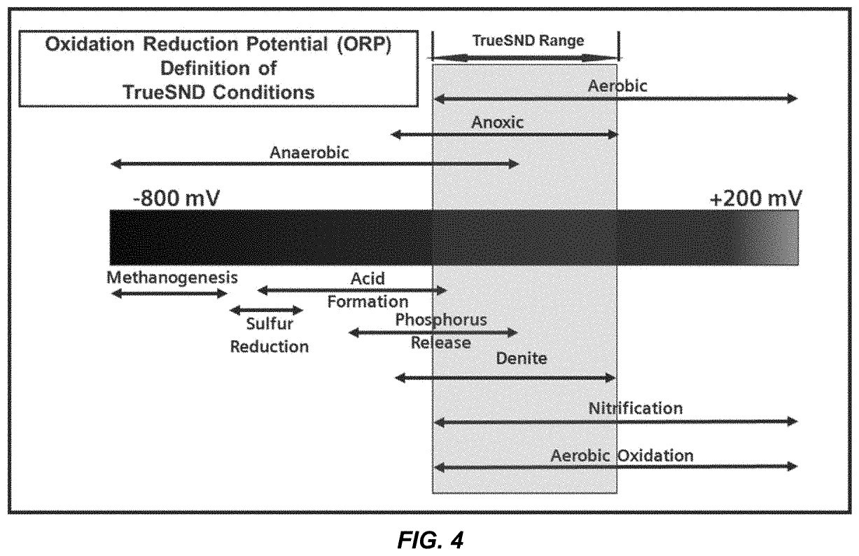

To control the SNDN system it is possible to use an oxidation reduction potential (ORP) measurement. ORP may be affected by aeration, which generally dictates DO in the wastewater. FIG. 4 illustrates typical ORP conditions used in wastewater treatment. Thus, it is possible to measure and control DO utilizing an ORP sensor, in addition to a dissolved oxygen sensor. It is also possible to control the SNDN process by measuring the nitrogen (e.g., ammonia, N₂, nitrate or nitrite) concentration in the wastewater.

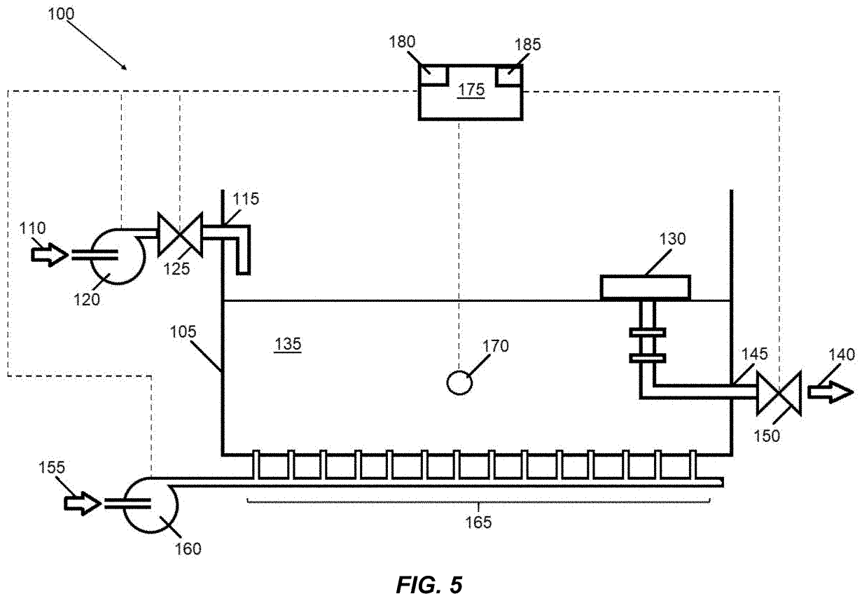

A simplified diagram of an SBR that may be utilized in various aspects and embodiments disclosed herein is illustrated in FIG. 5, indicated generally at 100. The SBR 100 may include a vessel 105 that receives wastewater 110 from a source of wastewater at an inlet 115 of the vessel 105, for example, via a wastewater pump 120 and control valve 125. A decanter 130, which may include a portion that floats on liquid 135 in the vessel 105, may drain effluent 140 through an outlet 145 of the vessel 105, optionally controlled by an output control valve 150. An oxygen-containing gas 155, for example air, may be provided to the liquid 135 in the vessel 105 via an air pump 160 to a series of aerators 165. Aerators 165 are illustrated as bubbler-type aerators located at the floor of the vessel 105, but it should be appreciated that in other embodiments other forms of aerators, for example, surface aerators, may also or additionally be utilized.

At least one sensor 170, for example, any one or more of a DO, ORP, or nitrogen (e.g., ammonia, N₂, nitrate or nitrite) concentration sensor, may be utilized to provide data to a controller 175. The controller 175 may receive and utilize such data to control the various sub-systems of the SBR 100, for example, to control the air pump 160 to achieve or maintain a desired level of DO or ORP in the liquid 135 in the vessel 105. The indication of sensor 170 may collectively refer to at least one sensor configured to measure an oxygen demand (COD or BOD) of the liquid 135 (e.g., and ORP or nitrogen concentration sensor) and at least one sensor configured to measure a concentration of dissolved oxygen in the liquid 135.

The controller 175 (or any other controller(s) disclosed herein) may be associated with or more processors 180 typically connected to one or more memory devices 185, which can comprise, for example, any one or more of a disk drive memory, a flash memory device, a RAM memory device, or other device for storing data. The memory device 185 may be used for storing programs and data during operation of the system. For example, the memory device 185 may be used for storing historical data relating to the parameters over a period of time, as well as operating data. In some embodiments, the controller(s) disclosed herein may be operably connected to an external data storage. For instance, the controller may be operable connected to an external server and/or a cloud data storage.

Any controller(s) disclosed herein may be a computer or mobile device or may be operably connected to a computer or mobile device. The controller may comprise a touch pad or other operating interface. For example, the controller may be operated through a keyboard, touch screen, track pad, and/or mouse. The controller may be configured to run software on an operating system known to one of ordinary skill in the art. The controller may be electrically connected to a power source.

The controller(s) disclosed herein may be digitally connected to the one or more components. The controller may be connected to the one or more components through a wireless connection. For example, the controller may be connected through wireless local area networking (WLAN) or short-wavelength ultra-high frequency (UHF) radio waves. The controller may further be operably connected to any additional pump or valve within the system, for example, to enable the controller to direct fluids or additives as needed. The controller may be coupled to a memory storing device or cloud-based memory storage.

The controller(s) disclosed herein may be configured to transmit data to a memory storing device or a cloud-based memory storage. Such data may include, for example, operating parameters, measurements, and/or status indicators of the system components. The externally stored data may be accessed through a computer or mobile device. In some embodiments, the controller or a processor associated with the external memory storage may be configured to notify a user of an operating parameter, measurement, and/or status of the system components. For instance, a notification may be pushed to a computer or mobile device notifying the user. Operating parameters and measurements include, for example, properties of the wastewater to be treated or a mixed liquor. Status of the system component may include, for example, current cycle of the reactor, cycle time, and whether any system component requires regular or unplanned maintenance. However, the notification may relate to any operating parameter, measurement, or status of a system component disclosed herein. The controller may further be configured to access data from the memory storing device or cloud-based memory storage. In certain embodiments, information, such as system updates, may be transmitted to the controller from an external source.

Multiple controllers may be programmed to work together to operate the system. For example, one or more controller may be programmed to work with an external computing device. In some embodiments, the controller and computing device may be integrated. In other embodiments, one or more of the processes disclosed herein may be manually or semi-automatically executed.

In most cases, the SBR wastewater treatment systems disclosed herein may be used to treat a normal flow of incoming wastewater. However, variations in flow conditions and contaminant concentration in the incoming wastewater streams, typically known as the influent or influent stream, periodically occur. Under normal conditions, wastewater flow varies because of ordinary fluctuations in household water use and discharge. Rainstorms and other wet weather events draining into a wastewater collection system, in many instances, produce higher than normal wastewater flow. Storm surges, for example, may be associated with wastewater flows between 40 MGD and 100 MGD. Conventional systems may not be equipped to handle surges greater than about 50 MGD for a sustained period of time. Although these high flow situations occur infrequently, about 10 to 25% of the time on a yearly basis, wastewater treatment facilities must be flexible and accommodate such overflows.

Systems and methods disclosed herein may involve the treatment of wastewater in a sequencing batch reactor wherein the wastewater, in quantities above a pre-selected minimum amount, may be proportionally aerated. For example, sequencing batch reactors may have volumetrically controlled withdrawals. A storm control procedure may be used to shorten cycle times according to the magnitude of the rate.

In accordance with certain embodiments, the systems and methods disclosed herein may relate to a wastewater treatment system capable of operating in a high flow situation as described in U.S. Patent Application Publication No. 2021/0094852 titled “Sequencing Batch Reactor Systems and Methods,” incorporated herein by reference in its entirety for all purposes.

The incidence of high flow situations may vary daily, seasonally, and/or by geographic region. Certain times of day or seasons of the year, for example, may typically be associated with a greater incidence of high flow situations. The incidence may also vary depending on geographic location, with certain areas being more prone to high flow situations than others. The systems and methods disclosed herein may take advantage of these patterns of high flow to adequately respond to an estimated or perceived high flow situation.

The SBR wastewater treatment systems disclosed herein predominantly operate and decontaminate as SNDN batch flow treatment systems. During high flow incidences, the wastewater treatment systems may operate and decontaminate as a continuous influent flow treatment system, typically as a continuous flow batch reactor (CFBR). When the wastewater treatment system operates or treats wastewater in the batch flow mode, the reactor in the wastewater treatment system performs treatment steps or periods on a batch quantity of influent contained in the reactor before discharge. In contrast, when the wastewater treatment system operates in the continuous flow mode, a continuous flow of influent enters the reactor while the reactor cycles through the treatment steps.

One drawback of systems operating exclusively in SNDN batch flow mode is the ability to handle increased influent flow rates. SBR systems typically have connections to storm water drains. When a storm event occurs the flow rate to the waste treatment facility can dramatically increase. The increase can be often two to five times the normal influent flow. If the treatment system cannot handle the increased flow, the excess flow is typically discharged to the environment untreated. This is an undesirable condition. The systems and methods disclosed herein involve SBR systems capable of adjusting operating parameters of the system in response to a high flow event. In particular, the systems and methods may be capable of adjusting operating parameters in response to an anticipated high flow event, with sufficient time to complete a transition cycle before the increased flow reaches the treatment system. Increased flow events may be associated with precipitation or increased sewerage flow rate. Precipitation may include any product of the condensation of atmospheric water vapor, for example, rainfall, snow, hail, sleet, or combinations thereof. Sewerage may include any water transported through a sewer system or directed to a sewer system.

As disclosed herein, the continuous flow mode may be associated with a hydraulic loading rate of between about 25% and about 50% of the hydraulic loading rate associated with a batch flow mode. During the continuous flow mode, wastewater may be dissipated across all reactors operating in continuous mode simultaneously. For systems that have between 2 and 4 reactors operating in continuous flow mode, the hydraulic flow of wastewater to each reactor may be reduced to about 50%, about 33%, or about 25% of the conventional batch mode reactor flow. Accordingly, reactors operating in continuous flow mode may be capable of treating high flow rate events.

Previous systems were equipped to switch from normal operation, e.g., batch flow mode, to continuous flow mode responsive to a measured flow rate at an inlet or within the system. At a low transition flow rate, such a design risks activation during routine transitory high flow periods, such as during the morning rush. At a high transition flow rate, such a design may not allow sufficient capacity or time for the system to transition to continuous flow mode without discharging inadequately treated water. To provide adequate treatment, the design requires an additional 20%-30% reactor volume, which is associated with high costs and makes retrofitting existing systems challenging and expensive.

The systems and methods disclosed herein involve switching from an SNDN batch flow mode to continuous flow mode responsive to an anticipated flow rate at an inlet or within the system, and not only a measured flow rate. In certain embodiments, the systems and methods assign activation of the transition to a plant operator so that the trigger is activated only when appropriate. In other methods, a controller may incorporate learned control to determine whether the anticipated flow rate will require a transition to the continuous flow mode.

Thus, in accordance with certain embodiments, the systems disclosed herein may be equipped with a flow mode controller, optionally the SNDN operation controller may be equipped to operate the system in an increased flow situation. The controller may regulate the wastewater treatment system, monitor the wastewater flow, monitor at least one parameter of the reactor, and determine the mode of operation. In certain embodiments, the controller may determine whether to switch operation of the wastewater treatment system from a batch flow mode to a continuous flow mode, and optionally back to a batch flow mode. In certain embodiments, methods of modifying or retrofitting an existing batch flow treatment system with minimal significant capital expenditure, are disclosed. The methods may provide a cost-effective upgrade solution for situations where such existing systems have insufficient treatment capacity.

In accordance with certain embodiments, the systems and methods disclosed herein may relate to a wastewater treatment system having a flow control as described in U.S. Pat. No. 6,383,389 titled “Wastewater treatment system and method of control,” incorporated herein by reference in its entirety for all purposes. The wastewater treatment system may include a wastewater treatment apparatus fluidly connected to the influent system and have a pump and a valve. The wastewater treatment system may also comprise a regulating apparatus controlling one of the pump and the valve and comprise a flow mode controller and an input apparatus for providing at least one input signal. The flow mode controller may analyze the at least one input signal and generate an output signal configured for one of a batch flow mode and a continuous flow mode.

In some embodiments, the controller may be operatively connected to a sensor in the wastewater treatment system for receiving at least one input signal. The controller may further comprise a microprocessor for receiving and analyzing the at least one input signal according to a logic program code and generating an output signal corresponding to one of a batch flow mode and a continuous flow mode to operate the system. In certain embodiments, the controller may process more than one input signal to produce the output signal. The flow mode controller may also be operatively connected an output apparatus for transmitting the output signal and actuating a valve to regulate a flow in the wastewater system in one of the batch and the continuous flow modes.

Thus, in some embodiments, the methods for treating a wastewater stream may comprise introducing the wastewater stream into a wastewater treatment system and measuring at least one parameter associated with the flow mode. The method may comprise comparing the measured parameter(s) to a predetermined setpoint. The method may also comprise operating the wastewater treatment system in one of a batch flow mode and a continuous flow mode according to the measured parameter(s), for example, according to a relationship between the measured parameter(s) and the predetermined setpoint. Exemplary parameters include expected precipitation, actual precipitation, expected sewerage flow rate, and actual sewerage flow rate. Expected precipitation may include, for example, precipitation estimated from a weather forecast. Actual precipitation may include, for example, precipitation measured with a rain or other sensor. Expected sewerage flow rate may include, for example, a sewerage event estimated from geographic location, time or year, and/or time of day. Actual sewerage flow rate may include, for example, a measured or detected sewerage flow rate, such as one associated with an infrastructure failure or malfunction.

In some embodiments, the method may comprise sequencing the periods of treatment of the wastewater treatment system in a batch flow mode during operation and sequencing the periods of treatment of the wastewater treatment system in a continuous flow mode during a revised operation. In such embodiments, the revised operation may be actuated responsive to a greater anticipated flow rate. In particular, the revised operation may be actuated responsive to an anticipated flow rate that is greater than a flow rate tolerated by the reactor. In some embodiments, the anticipated flow rate may be associated with a storm surge. The anticipated flow rate may be determined responsive to at least one of a predicted weather event, predicted sewerage event, time of day, time of year, and geographic location.

The systems and methods disclosed herein also incorporate independent control of each reactor. The methods may employ a reactor-by-reactor transition decision which addresses the unique conditions in each reactor and controls the transition between modes as and when appropriate. These features may allow the operating mode switch to be activated only when an increased flow event, such as a storm, is expected. One benefit is that the transition can therefore be initiated early when influent flow rates are still relatively low and reactors have time to increase their spare capacity. The transition may also be performed infrequently. The systems and methods disclosed herein may additionally reduce or eliminate the incidence of discharging inadequately treated water due to a sudden influx of wastewater.

Thus, in some embodiments, the method may comprise transmitting at least one process signal corresponding to an operating condition of each reactor. The operating condition of the reactor may be associated with the reactor's capacity to operate in a continuous flow mode. Exemplary parameters which may be considered in determining the operating condition of the reactor include available fill volume, influent water composition, process water composition, and hydraulic loading rate. The method may further comprise analyzing the at least one process signal and providing an output signal corresponding to one of the batch flow mode of operation and the continuous flow mode of operation according to a set of predetermined conditions. The method may also comprise actuating a valve based on the output signal.

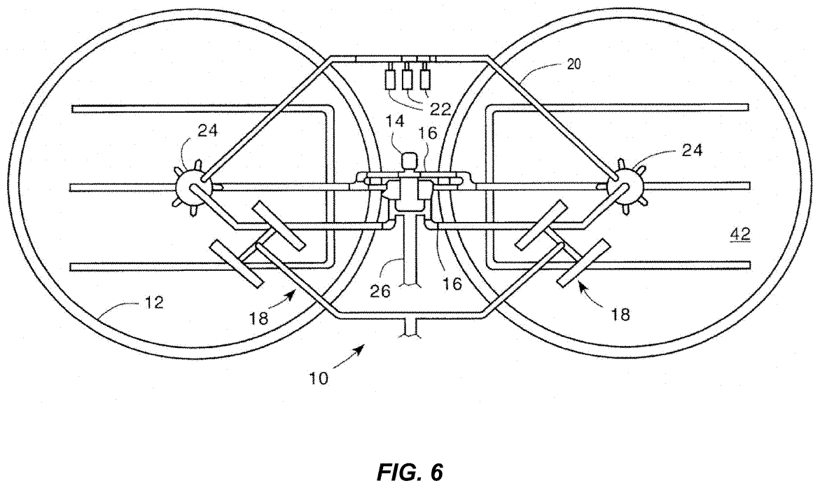

In accordance with certain embodiments, a wastewater treatment system 10 is shown in FIG. 6 with a reactor 12 and a pumping system with pump 14 connected to a piping manifold 16. Two reactors are shown in FIG. 6, however, the systems disclosed herein may include more reactors. Systems may include, for example, 2, 3, 4, 5, or 6 reactors. The wastewater treatment system 10 may be a sequencing batch reactor system.

In some embodiments, each reactor may include an emergency float switch located near the full capacity liquid level of the reactor. For instance, the reactor may have an emergency float switch located about 1 ft from the top of the reactor. The reactor may have an emergency float switch located at a height which substantially corresponds to about 95% fill volume, about 90% fill volume, about 85% fill volume, or about 80% fill volume. The controller may be configured to shut the influent valve responsive to influent flow reaching the emergency float switch.

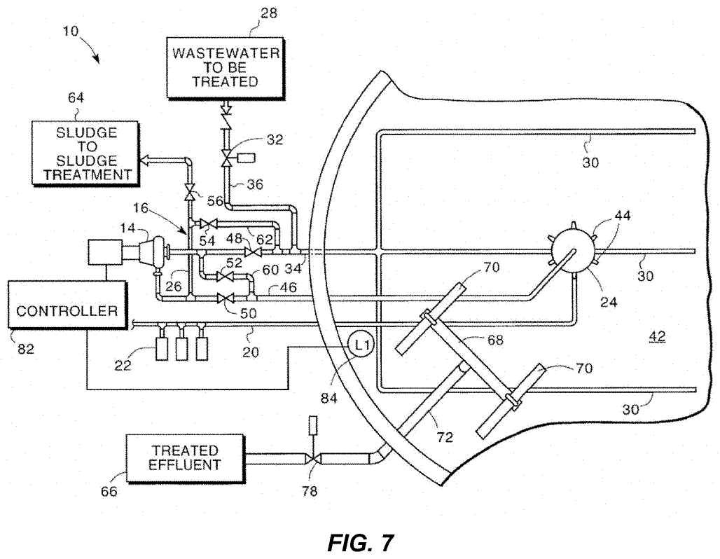

FIG. 6 shows each reactor associated with a decanting system 18, an aeration system with a conduit 20, an air source 22, a distribution structure 24 and a sludge conduit 26. The reactor may be fluidly connectable to a source of wastewater 28 (shown in FIG. 7). Wastewater, for example, from a municipal or industrial source, flows into the reactor through a filling system through the piping manifold 16 and a distribution conduit 30 (shown in FIG. 7) located near the bottom of reactor 12. In the partial view of FIG. 7, piping manifold 16 includes at least one influent valve 32, for throttling and regulating the influent flow, conduits 34 and 36, fluidly connected to valve 32 and to distribution conduit 30. In some embodiments, the filling system may include at least one baffle wall to dissipate any inlet turbulence. Influent valve 32 may provide flow control to reduce or prevent backflow. For example, influent valve 32 may be a check valve. In some embodiments, piping manifold 16 may include a pump or flow meter to provide flow control. The pump or flow meter may be configured to control influent flow independently to each tank.

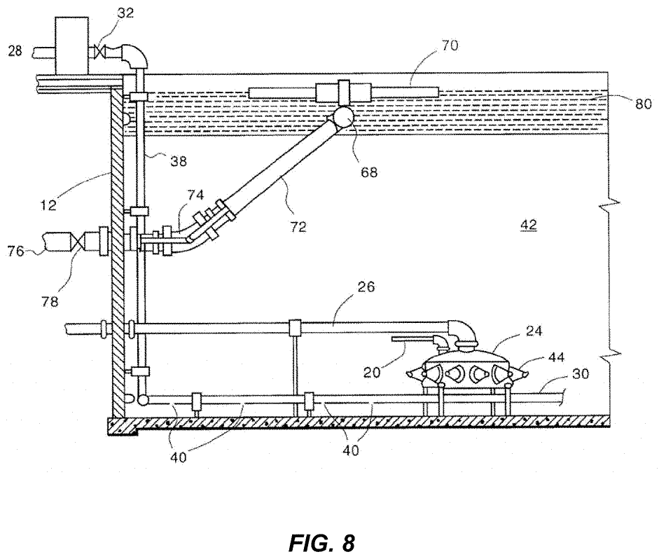

As shown in the partial cross-sectional view of FIG. 8, distribution conduit 30 connects to wastewater source 28 through a downcomer or riser 38. Each distribution conduit may have a plurality of apertures 40 spaced along its length through which influent enters reactor 12 and joins with the liquid 42.

In certain embodiments, the influent system may include at least one baffle wall. Also, the influent system may include a distribution system having at least one baffle wall that allows influent to enter reactor 12 without substantially disturbing liquid 42 or at least preventing any significant turbulence in liquid 42 that destroys anoxic conditions. The prevention of turbulence may be employed, for example, during the continuous flow mode.

In certain embodiments, the distribution system may include a header fluidly connected to the plurality of reactors. The distribution system may include a flow splitter fluidly connected to the plurality of reactors. The header or flow splitter may include a baffle wall and be configured to distribute influent equally to the reactors and/or prevent backflow from the reactors. The header or flow splitter may be configured to prevent discharge of the influent into the decanter. In practice, the influent wastewater may flow up and over the reactor wall and into a baffle.

In certain embodiments, the wastewater treatment systems disclosed herein may include a surge tank positioned upstream from the reactor or system. When the flow rate of the incoming wastewater exceeds a selected level, incoming wastewater may flow into the surge tank until the surge has subsided.

The wastewater treatment systems disclosed herein also may have an aeration system supplying air or oxygen to liquid 42. As shown in FIG. 6, the aeration system may have at least one distribution structure 24 connected to at least one air source 22 by conduit 20. Further, distribution structure 24, as shown in FIG. 7, has a number of nozzles 44 positioned around its perimeter through which air passes and contacts liquid 42.

The aeration system may be used as a mixing system by introducing air or liquid at a rate sufficient to create turbulence and effect mixing of liquid 42. Thus, in one embodiment air enters reactor 12 from air source 22 through nozzles 44 of distribution structure 24 at a rate that promotes mixing of liquid 42. In another embodiment, mixing of liquid 42 may be effected by withdrawing at least a portion of liquid 42 through, for example, apertures 40 along conduit 30, and introducing that withdrawn portion of liquid 42 through nozzles 44 of distribution structure 24 at a rate sufficient to create turbulence and mixing of liquid 42.

As shown in FIG. 7, the pumping system typically includes at least one pump 14 fluidly connected to manifold 16 to circulate, transfer or move fluid. In the exemplary embodiment of FIG. 7, pump 14 connects to conduits 26, 34 and 46 of manifold 16 through valves 48, 50, 52, 54 and 56. Additional connections in manifold 16 may include conduit 60 connecting conduit 46, downstream of valve 50, to conduit 34, between pump 14 and valve 48; and conduit 62 connecting conduit 34, between valve 48 and conduit 36, to conduit 26 before valve 56. Other similar connections in manifold 16 may be included to provide flexible operation and control of the wastewater treatment system. For example, additional connections may be provided to other reactors so that fluids may be transferred from one reactor to another.

In some exemplary embodiments, the wastewater treatment system further includes a sludge removal or withdrawal system for withdrawing or removing sludge or solids collected near the bottom of the reactor to a sludge treatment facility 64. For example, referring to the embodiment illustrated in FIG. 7, conduit 34 connects distribution conduit 30 to the inlet or suction side of pump 14 through valve 48. Conduits 26 and 46 connect the pump discharge to the sludge treatment system 64 through valve 56. In this manner, the pumping system may be operated, in conjunction with proper valve alignment, to remove sludge from reactor 12.

In some embodiments, the wastewater treatment system may include at least one decanting system 18 for withdrawing a substantially clear layer near the top of the liquid 42 and discharging to effluent disposal 66. The embodiment of decanting system 18 shown in FIG. 6 includes at least one receiver apparatus 68, identified in FIG. 7, with at least one flotation apparatus 70. Flotation apparatus 70 provides sufficient buoyancy to the decanting system so that receiver apparatus 68 remains near the top surface of the liquid 42. Typically, receiver apparatus 68 withdraws a substantially clear layer of liquid 80, shown in FIG. 8. In the receiver apparatus, the liquid, as effluent, flows through conduits 72, 74 and 76 and discharges to effluent disposal 66 through effluent valve 78. In operation, the decanting system may transfer the top layer of liquid 42 without pumping assistance.

Alternatively, the decanting system may connect to piping manifold 16 and to the pumping system. In this arrangement, the suction side of pump 14 connects to the decanting system through at least one of conduits 72, 74 and 76. The discharge side of pump 14 then connects to the effluent disposal 66 through conduit 46 and effluent valve 78. Thus, the pumping system may be operated to assist the decanting system in transferring or removing the top layer of liquid 42.

A controller may be employed for monitoring and/or operating the treatment facility. The controller typically receives at least one input signal associated with the process conditions of each reactor in the wastewater treatment system and determines and analyzes the at least one input signal to control the reactors. The controller typically generates at least one output signal to direct, provide, and effectuate such control. In one embodiment, the controller determines an anticipated flow rate, compares that anticipated flow rate to a set-point associated with a design hydraulic loading rate of the reactor, and then directs operation of the wastewater treatment system according the SNDN batch mode or a continuous flow mode. The controller may additionally determine a state of the reactor when selecting one or more reactor to transition between the SNDN batch flow mode and the continuous flow mode. Further, the controller may be configured to be sufficiently flexible and adaptive to ignore transient or intermittent operating conditions in the treatment system. For example, the controller may be sufficiently adaptive to ignore transient spikes in influent flow measurements which do not immediately require a change in operating mode.

The design hydraulic loading rate of a reactor may refer to a maximum hydraulic loading rate tolerable by the reactor to produce effectively treated effluent. The design hydraulic loading rate may consider a flow rate of wastewater into the reactor and a flow rate of effluent out of the reactor.

The exemplary system as shown in FIG. 7 includes controller 82, which may be automated, providing at least one output signal to a loading subsystem which typically includes at least one output apparatus or device. For example, the output apparatus or device may be selected from one of the valves 32, 48, 50, 52, 54, 56 and 78. The loading subsystem may be configured to control a hydraulic loading rate of wastewater into each of the reactors through the inlet. The loading subsystem may be configured to control loading and decanting of the reactors. Controller 82 also may provide an output signal to pump 14 and air source 22. In another embodiment, the controller may include or be operatively connected to at least one of a radio or other type of wireless interface, a peer input and output serial and/or parallel port (I/O port), an internal real time clock and a process display capable of portraying and/or printing or recording the operational status of the wastewater treatment system. These peripheral components are typically included to accommodate flexible operation of the system and may provide for subsequent modifications.

The controller may operate automatically with one or more reactors in automatic mode and may allow for maintenance, equipment failure, or operator control. In particular, the controller may be operatively connected to an operator control device. The operator control device may be used to transmit an input signal for an anticipated flow rate or a state of a reactor. In practice, the operator control device may be a mouse, keyboard, trackpad, mobile device, or other electronic device, which can be used to signal the controller to transition at least one reactor between batch and continuous mode at the present time or at a predetermined future time. The operator control device may also be used to signal the controller for operation of the SNDN batch flow mode, as previously described.

The controller may additionally transmit one or more output signal to the operator control device for notification of the status of the system. Such an embodiment may allow for monitoring and control of the system from a remote location. In certain embodiments, the controller may be configured to detect failure of critical equipment, such as influent valves, air sources, air valves, or decant systems. During such conditions, the controller may notify an operator and optionally automatically operate to remove the failed reactor, or the reactor associated with the failed equipment, from service and provide alarm or warnings accordingly.

In certain embodiments, the system includes a measuring subsystem including at least one input apparatus 84 operatively connected to controller 82. The measuring subsystem may be configured to measure at least one parameter of each of the reactors. The exemplary embodiment illustrated in FIG. 7 depicts a fluid level sensor or indicator providing at least one input signal to the controller 82. The level indicator typically transmits a 4 to 20 milliamp (mA) analog signal corresponding to a height or level of liquid 42 in reactor 12. An analog to digital converter (A/D converter) may convert that transmitted analog signal to a digital signal and transmit the digital signal to controller 82. However, other types of input apparatus, such as a flow meter, a pressure sensor, a composition analyzer, and a temperature indicator or an on/off-indication level sensor, may be connected to provide similar input signals, singly or in combination, to one of the A/D converter and controller 82. For example, the input apparatus may include a flow meter in conduit 36 measuring the influent flow rate, another flow meter in conduit 76 measuring the effluent flow rate, another flow meter in conduit 20 measuring the air flow rate, and a composition analyzer, such a chromatograph, in conduit 76 measuring the composition of the effluent.

Thus, in some embodiments, the input device may be a keypad, or other man-machine-interface such as a computer with a keyboard and a graphical interface, which provides the operator of the treatment facility the capability to monitor, operate and control individual components of the treatment system. The input device may be the operator control module having a graphical interface as described herein. For example, the interface may show the particular step in the treatment cycle for each reactor and the status of each valve in the treatment system as well as elapsed cycle time, elapsed step time, and even treatment set-points.

The output signal or signals from controller 82 may be a digital or analog signal directing at least one of valves 32, 48, 50, 52, 54, 56, 78, pump 14 and air source 38. Alternatively, controller 82 may send a digital output signal or signals to a digital to analog converter (D/A converter) to control any of the output apparatus. For example, controller 82 may generate a digital output signal which may then be converted to a 4 to 20 mA analog signal, or a 3 to 15 lbf/in² pneumatic analog signal, by the D/A converter. This analog signal may be sent to any of the valve or valve actuator or control center to throttle the valve or to energize the pump or air source. Notably, the connection between controller 82 any of the input or output apparatus may be by wire or may be wireless. In certain embodiments, the controller 82, and any of the input or output apparatuses, may be operatively connected through one or more servers and/or cloud-based systems.

The wastewater treatment system may further comprise or be operably connectable to an anticipated flow rate analyzer. The anticipated flow rate analyzer may be configured to measure at least one flow rate parameter which may have an effect on the anticipated flow rate. In accordance with certain embodiments, the flow rate analyzer may include a flow meter or a rain or precipitation sensor. The flow rate analyzer may be configured to transmit anticipated flow rate information to the controller. For example, the rain or precipitation sensor may be configured to transmit actual precipitation information to the controller. The flow meter may be configured to transmit actual sewerage information to the controller.

The controller may receive at least one input signal of actual precipitation or sewerage and determine that a surge of wastewater will imminently reach the wastewater treatment system. In accordance with certain embodiments, the controller may be configured to transition from batch flow mode to continuous flow mode responsive to a precipitation of greater than about 2 in/hour. The controller may be configured to transition from batch flow mode to continuous flow mode responsive to a detected or known sewerage event, such as a sewerage infrastructure failure or malfunction, for example, a broken or malfunctioning pipe, levee, or dam. The controller may additionally consider one or more of a predicted weather event, a predicted sewerage event, time of day, time of year, and geographic location in determining the anticipated flow rate.

The wastewater treatment system may additionally or alternatively be fluidly connected to a pre-treatment subsystem or a post-treatment subsystem. The pre-treatment and post-treatment subsystems may utilize any water treatment methods conventionally known in the art. In accordance with certain non-limiting embodiments, the pre-treatment and/or post-treatment subsystems may comprise one or more of a screen filter, a membrane filter, a reverse osmosis unit, an ion exchange unit, an ultraviolet treatment unit, a chlorine dosing unit, a sand filter, and a primary or secondary treatment unit such as a clarifier or settling tank. The wastewater may be treated to remove bulk solids before treatment in the sequencing batch reactor system. The effluent may be treated to produce water of any desired quality, for example, potable water, deionized water, or ultrapure water, as known to one of skill in the art. The wastewater treatment system may additionally be fluidly connected to one or more equalization tank upstream or downstream from the reactors. The wastewater treatment system may additionally or alternatively be fluidly connected to one or more surge tank upstream from the reactors.

In operation, the wastewater treatment system may decontaminate influent in a batch flow mode or in a continuous flow mode. Specifically, the batch flow mode of operation treats the influent in batches according to an SNDN treatment operation, as previously described. Treatment steps during the batch flow mode may be performed sequentially on a batch quantity of wastewater. Furthermore, during SNDN batch flow treatment, influent wastewater is generally delivered to each reactor of the system in series. Thus, the reactors may operate in a staggered configuration. In contrast, the continuous flow mode of operation treats a continuously flowing wastewater stream so that the reactors continuously accept influent while performing the treatment steps. All reactors in the continuous flow mode may receive a portion of the influent wastewater simultaneously, at the same or different flow rates.

Specific control of the wastewater treatment system, including specific control of the reactors in the wastewater treatment system in either the batch flow or continuous flow modes, depend on several factors including, for example, liquid level, influent flow rate, contaminant concentration, ambient conditions and effluent flow rate.

Thus, in accordance with certain aspects, controller 82 may operate based on at least one transition set-point associated with an anticipated flow rate and a period of time, so that in operation when an anticipated flow rate falls below the transition set-point, controller 82 sequences the reactors in the batch flow mode. When the anticipated flow rate is determined to be at about or above the transition set-point for a predetermined period of time, controller 82 independently selects one or more reactors, depending on several factors including, for example, the particular treatment step at the switching instant, to begin transition to continuous flow mode. Conversely, when the anticipated flow rate is determined to fall below the transition set-point for a predetermined period of time, or other conditions become apparent which no longer require high flow capacity, controller 82 independently selects one or more reactors, depending on the same or similar factors, to begin transition from continuous flow mode to batch flow mode.

Thus, a time factor may be considered, for example, the transition between modes may occur when the anticipated flow rate will change for at least a predetermined period of time. The time factor may be considered to avoid false positive set-points. Namely, the time factor may be considered to avoid transition for transient events. In certain embodiments, the time factor may be associated with hydraulic loading rate of the reactor. For instance, predetermined period of time may correspond to an amount of time it would take to fill at least 20% of the reactor at that hydraulic loading rate. The predetermined period of time may correspond to an amount of time it would take to fill 20%, 50%, 70%, 100%, 150%, or 200% of the reactor at that hydraulic loading rate.

The controller may additionally or alternatively independently select a hydraulic loading rate for each reactor including, for example fill rate and/or decant rate. The hydraulic loading rate may be proportional to available fill volume in the reactor. In some embodiments, the controller may independently select fill rate for each reactor corresponding to wastewater flow rate and available fill volume. In some embodiments, the controller may independently select decant rate for each reactor corresponding to wastewater flow rate, available fill volume, and remaining filled decant time. The decant rate may be selected so as to meet a desired bottom water level in the remaining filled decant time.

As mentioned, the batch flow mode may include SNDN treatment steps, such as, first, second, or third treatment regimes, settling, decanting, or idling. The sequencing and duration of these batch flow steps may be varied through the program by programmed control algorithms including, for example, fuzzy logic or artificial intelligence. The continuous flow mode may include treatment steps, such as, anoxic fill, aerated fill, filled settle, and filled decant. As with the batch flow mode, the sequencing and duration of these continuous flow steps may be varied by preprogrammed control algorithms including, for example, fuzzy logic or artificial intelligence. Moreover, the controller may operate based on a series of set-points corresponding, for example, to incremental influent conditions that trigger step-wise, or continuous, modification of each treatment step, in either the batch flow mode or continuous flow mode, so that the duration of one or more treatment step may be accordingly shortened or lengthened depending, for example, on the influent flow rate and influent or effluent contaminant concentration.

Further, the controller may consider control loops that control or supervise components or subsystem of the wastewater treatment system. Specifically, individual control loops may involve any or a combination of proportional, integral or differential controls. These control loops may exist and operate independent of the program or may reside within the program. For example, the controller may operate based on control loops that control each reactor or each valve, pump or even step in each of the SNDN batch or continuous flow modes. These individual loops typically require specific tuning or adjustment according to any of control loop performance, valve performance, and/or actuator performance.

The controller may implement programmed control algorithms including, for example, fuzzy logic or artificial intelligence, in determining the anticipated flow rate. In accordance with certain embodiments, the controller may be programmable to recognize trends of the anticipated flow rate on a schedule. The controller may consider parameters such as predicted weather events, predicted sewerage events, time of day, time of year, and geographic location in determining the anticipated flow rate. The controller may thus be capable of operating the wastewater treatment system responsive to the recognized trends.

The measuring subsystem may be include at least one input apparatus, for example, a sensor. In accordance with certain embodiments, the input apparatus may send an analog or digital input signal corresponding to the level of liquid 42 in the reactor. An A/D converter changes this analog signal to a digital signal according to a predetermined conversion factor. Controller 82 receives the input signal and calculates a liquid level and simultaneously compares the liquid level against the set-point or set-points. The controller 82 may convert the liquid level input signal to determine available reactor volume. In some embodiments, the controller 82 may receive at least one input signal through at least one I/O port.

During the batch flow mode, if, for example, the liquid level is at or above a set-point (more particularly, if the available volume is at or below a set-point), controller 82 may terminate the filling cycle for that filling reactor and divert influent flow to the next available reactor. Specifically, controller 82 sends an output signal, typically a digital output signal that corresponds to actuating at least valve 32. This output signal may be sent through an I/O port to a D/A converter. The D/A converter my change the digital output signal to a 4 to 20 mA current in a 12 or 24 volt analog circuit or to a 3 to 15 lbf/in² pneumatic actuation signal. The output apparatus, valve or the actuator of valve 32 in this example, receives the analog output signal and reacts accordingly. Similar output signals may be generated by controller 82 for other output apparatus. At the end of the filling step, controller 82 may prepare the reactor for the next step.

While the disclosure refers generally to digital signals, analog signals, pneumatic signals, D/A or A/D converters, and/or I/O ports, it should be noted that the system may be equipped with any infrastructure to receive, convert, and/or send signals as known to one of ordinary skill in the art. Additionally, the various system components, such as the controllers, input devices, and output devices, may be equipped to receive, convert, and/or send any type of signal encoding the relevant information.

During a transition to continuous flow mode, or upon receiving an indication that the anticipated flow rate is above a set-point, the controller 82 may receive an input signal from the measuring subsystem corresponding to a level of liquid 42 in one or more of the reactors. The controller 82 may determine the liquid level and available volume and compare the values against the set-point or set-points. If the liquid level is at or below a set-point (more particularly, if the available volume is at or above a set-point), controller 82 may begin transition for the given reactor from batch flow mode to continuous flow mode. The controller may independently select a reactor for transition responsive to an independent transition calculus performed for each reactor. A transition period which provides for adequate treatment of the liquid 42 within the reactor at that time may be initiated. After completion of the transition period, or after adequate treatment of the liquid 42, the controller 82 may send an output signal that corresponds to at least one effluent valve to begin continuous flow mode treatment. Upon selecting one or more reactor to transition to continuous flow mode, the controller 82 may send an output signal to distribute wastewater to all reactors transitioning to continuous flow mode.

The controller 82 may be configured to send an output signal to independently control wastewater to each reactor. In some embodiments, the controller 82 may direct wastewater to each reactor proportionately with a property of the reactor. For example, the methods may include directing wastewater to each reactor (for example, controlling flow rate of the wastewater directed to each reactor) proportionately with one or more of available fill volume, influent water composition, and mixed liquor composition. In other embodiments, the controller 82 may be configured to send an output signal to distribute wastewater substantially evenly to all reactors transitioning to continuous flow mode.

If any one or more reactor has a liquid level at or above a set point (more particularly, if the available volume is below a set-point), controller 82 may continue treatment in the batch flow mode and select a time point in the future to re-evaluate liquid level of the given reactor. The controller 82 may generally continue to evaluate the reactors for transition to continuous flow mode until all reactors have met the set-point and been instructed to transition. Notably, controller 82, or the A/D converter in certain embodiments, may sample or otherwise determine the liquid level at predetermined fixed or variable intervals. For example, the liquid level may be sampled or calculated once every millisecond or every second or only after a predetermined filling time has elapsed. In this manner, controller 82 may be optimized so to reduce its computational duties.

One or more other measurements may be considered, in addition to or instead of fill level, when selecting a reactor to transition between batch and continuous flow mode. For example, the controller 82 may receive at least one input signal from any input device in the measuring subsystem, as previously described. The measuring subsystem may comprise one or more of a flow meter, a pressure sensor, an oxidation-reduction potential sensor, and a dissolved oxygen sensor. The controller 82 may consider reactor fill level and/or reactor available volume in connection with current reactor treatment cycle, influent water composition, process water composition, and hydraulic loading rate. As described herein, reactor treatment cycle refers to a batch flow mode treatment step. The controller 82 may select one or more reactor being in a current treatment cycle which corresponds to available volume, for example, a fill stage, decant stage, or idle stage. The fill stage may be a first treatment regime or second treatment regime, as previously described. As described herein, hydraulic loading rate may refer to a fill and/or decant flow rate of the reactor.

In certain embodiments, as in the filling step of the batch flow mode, which may occur during the first treatment regime and part of the second treatment regime, and referring back to FIG. 5, influent typically flows into at least one reactor through conduit 36, downcomer 38 and through apertures 40 of distribution conduit 30. In an alternative arrangement, pump 14 withdraws influent and drives the influent to distribution conduit 30. Referring to FIG. 7, the specific valve arrangement for such flow configuration requires valves 32, 48 and 50 to be open while all other valves to be closed. As mentioned, the wastewater treatment system may be controlled according to a predetermined or programmed instruction. In an embodiment, controller 82 sends at least one output signal to valve or the actuator of valves 32, 48 and 50 to open or allow a desired flow through these valves. Simultaneously, controller 82 also sends output signals to valve or the actuators of valves 52, 54, 56, and 78 to close these valves and prevent fluid flow. Notably, filling may be performed with or without mixing or turbulence in the liquid. In certain embodiments, filling may be employed such that operation promotes distribution of influent without disruption of settled solids and helps control diversity or selectivity of biomass population.

One step in the batch flow mode may involve mixing the liquid in the filled or filling reactor. This step need not necessarily follow the filling step and may, in some cycles, overlap with other steps or may be eliminated. For example, this step may occur with the first, second, or third treatment regime. This step may involve withdrawing a portion of the liquid through distribution conduit 30. In one embodiment, liquid flows into the reactor through piping manifold 16 and distribution structure 24. In such configuration, for example, valves 48 and 50 are open and valves 32, 52, 54, 56 and 78 are closed. Thus, controller 82 sends output signals to allow a desired flow through valves 48 and 50 and to the control center to energize pump 14. Controller 82 may also send output signals to close valves 32, 52, 54, 56 and 78.

As previously described, the SNDN batch flow mode may include controlled aeration of liquid 42 in predetermined treatment regimes to promote nitrification and denitrification. In the consecutive treatment steps, a source of oxygen may oxygenate the liquid and the biomass to promote biological activity and digestion of biodegradable material. The source of oxygen may provide air, oxygen, or ozone. The source of oxygen, for example, air source 22, supplies air to distribution structure 24. Air leaves distribution structure 24 through nozzles 44 and contacts biomass in liquid 42. Aeration generally provides oxygen to the biomass to promote bioactivity and may promote, in some cases, mixing of the liquid and the biomass. In certain embodiments, and as previously described, controller 82 regulates aeration, optionally by activating air source 22 so that air becomes sufficiently pressurized to overcome the head pressure exerted by liquid 42 on distribution structure 24 thus forcing air to flow and bubble out through nozzles 44. An air valve (not shown) may also be controlled by controller 82 so that air flowing through conduit 20 may be regulated according to the SNDN batch flow mode treatment regimes, described above.

In the settling step, or quiescent settling of the SNDN batch flow mode, aeration may be terminated and the biomass, digested materials, and solids are allowed to settle. The settling step typically involves minimal or no liquid flow, entering or leaving the reactor. The settling step typically stratifies the liquid so that solids settle near the bottom, and a substantially clear layer, near the top of liquid 42, forms above the settled solids.

The decanting step withdraws the layer of substantially clear liquid 80, or liquid nearly free of solids, from the upper portion of the liquid in the reactor, through the decanting system. Substantially clear liquid flows into receiver apparatus 68, through conduits 72, 74, and 76, and discharges to effluent disposal 66 through effluent valve 78. If the pumping system also connects to the decanting system, the suction side of pump 14 receives fluid from receiver apparatus 68 and through at least one of conduits 72, 74 and 76. The discharge side of pump 14 discharges to effluent disposal 66. In some embodiments, controller 82 opens at least one of valve 78 and pump 14 and closes at least one of valves 32, 48, 50, 52, 54 and 56.

As with the decanting step, any sludge removal step of the batch flow mode typically, but not necessarily, follows settling. Notably, sludge removal may continue into the treatment steps following settling or may proceed with the decanting step. In the sludge removal step, an amount of sludge, essentially settled solids, may be withdrawn from the reactor when pump 14 draws in the sludge near the bottom of the reactor through apertures 40 of conduit 30. Pump 14 discharges the sludge to sludge treatment 64 through conduit 26. In some embodiments, controller 82 generates output signals to open valves 48 and 56 and close valves 32, 50, 52 and 54.

The batch flow mode may further include an idle step wherein significantly all systems remain idle. Ordinarily, the duration of this step varies according to influent conditions so that as the influent rate increases, idle time decreases. However, this step need not necessarily exclusively vary depending on the influent conditions. For example, any of the other batch flow mode steps may be varied proportionally according to operating conditions or as determined by the operator.

At the outset of the continuous flow mode, the reactor may go through a transition period. Typically, during the transition from the SNDN batch flow mode to continuous flow mode, one or more treatment step is performed to prime the reactor for continuous flow mode operation. For instance, if the reactor is partially full of treatment fluid from a batch flow mode, the fill volume may not be sufficiently treated for discharge. The reactor may undergo one or more treatment step selected from, for example, a react cycle and a settle cycle, before decanting any treated fluid. The react cycle may include one or more of mixing and aerating steps. The additional treatment steps may be performed while the reactor is filling or idle, but prior to decanting. In accordance with certain embodiments, the time for the transition period treatment step may correspond to the current fill volume, similar to a variable time cycle.

In certain embodiments, the transition period to continuous flow mode may take between about 30 mins and 90 minutes. The transition period may take, for example, about 30 minutes, about 45 minutes, about 60 minutes, about 75 minutes, or about 90 minutes. The transition period time may depend on the process water composition and fill volume of the reactor at the transition time. In general, the transition period may be sufficient to settle an effective amount of contaminants, such that operation during the continuous flow mode produces a sufficiently treated effluent. In certain embodiments, the anticipated flow rate may be a flow rate expected after the amount of time of the transition period. The controller 82 may determine the amount of time of the transition period for each reactor and begin the transition accordingly such that the anticipated flow rate becomes an actual flow rate after the transition period has been completed.

After the transition period, controller 82 may monitor the influent flow rate as measured by input apparatus 84 and generally sequence the valves and pumps of the wastewater treatment system according to the corresponding treatment step. Specifically, as with the batch flow mode, controller 82 may generate output signals during each step of the continuous flow mode to actuate, throttle, or close any of the valves, pump, and air source to regulate fluid through the wastewater treatment system. In the continuous flow mode, the wastewater treatment system may include at least one of a filling while aerating (aerated fill), mixing, settling (filled settle), and decanting (filled decant), in accordance with the SNDN operation methods described above.

Aeration may be introduced into the one or more reactor during the continuous flow mode in an effective amount to treat the wastewater. In general, the effective amount of aeration during the continuous flow mode may be less than the aeration during the batch flow mode. Additionally, the reduced flow rate associated with the continuous flow mode may allow a substantially simultaneous fill and decant while maintaining adequate treatment. In particular, during fill or during anoxic fill, which may continue during the filled settle and filled decant steps, influent may flow through piping manifold 36 and out through apertures of conduit 30. In another embodiment, controller 82 may actuate valves (not shown) controlling flow through each arm of conduit 30 to prevent short-circuiting of bypassing, where no or minimal digestion of influent occurs because it flows almost directly into the decanting system.

The aerated fill step allows biodigestion. Aeration during filling may continue from anoxic filling until the liquid level reaches the maximum level. At that point, filled settle may begin. In this step, controller 82 typically continues to monitor the level of liquid 42, through level indicator 84, while controlling and sending output signals. Additionally, controller 82 may send output signals to air source 22 or an air valve (not shown) in conduit 20 to throttle or regulate airflow through distribution structure 24. Controller 82 may also send output signals to close at least one of valves 48, 50, 52, 54, 56, and to de-energize pump 14.

The filled settle step typically follows the aerated fill step. The filled settle step permits settling of the biomass solids before the filled decant step and is substantially similar to the settling step of the batch flow mode. In particularly, controller 82 may send output signals to close all valves except for influent valve 32 which may be throttled to reduce the influent flow rate so as to minimize turbulence and disturbance of the settling process.

The filled decant step may involve withdrawal of the upper portion of the liquid through the decanting system. This step is also similar to the corresponding batch flow mode decanting step. Thus, controller 82 may generate corresponding output signals to open or close the corresponding valves to allow removal of the substantially clear liquid above liquid 42. In certain embodiments, the continuous flow mode further includes a sludge removal step during filling. This step, typically but not necessarily, follows the filled settle step. This step is also similar to the corresponding batch flow mode sludge removal step and thus, controller 82 would generate corresponding output signals to actuate the corresponding valves to allow sludge removal to sludge treatment 64.

During a transition period between a continuous flow mode and a batch flow mode the reactor may be primed for batch flow mode operation as previously described for the transition to continuous flow mode. Typically, during the transition from continuous flow mode to batch flow mode, one or more treatment step is performed to prime the reactor for batch flow mode operation. The transition period to batch flow mode may generally be shorter than described above with respect to continuous flow mode. For instance, the transition to batch flow mode may take between about 10 minutes and about 60 minutes. In particular, due to the increased flow rate of batch flow mode, the controller 82 may consider fill volume of the reactor when selecting the one or more reactor as being in a state capable of transitioning to batch flow mode. The controller 82 may consider a treatment step when selecting the one or more reactor as being in a state capable of transitioning to batch flow mode. For instance, in some embodiments the controller 82 may transition one or more reactor currently in filled settle or filled decant steps. An effective amount of effluent may be decanted prior to beginning a filling and/or treatment step of the batch flow mode.

In accordance with one aspect, one or more reactor may be transitioned from a batch flow mode to a modified batch flow mode, in a manner similar to any of the methods described herein for transitioning to a continuous flow mode. The modified batch flow mode may incorporate one or more cycle from the batch flow mode, while operating a substantially continuous flow mode. For instance, the system may distribute wastewater, for example, at an independently controlled flow rate or substantially evenly, as previously described, to all reactors operating in the modified batch mode. One or more of settle and decant may be performed without filling, as in a batch flow mode. The modified batch operation may avoid simultaneous decant by more than one reactor. The modified batch mode may tolerate a greater overall flow rate and produce effluent of a quality similar to true batch flow mode operation.

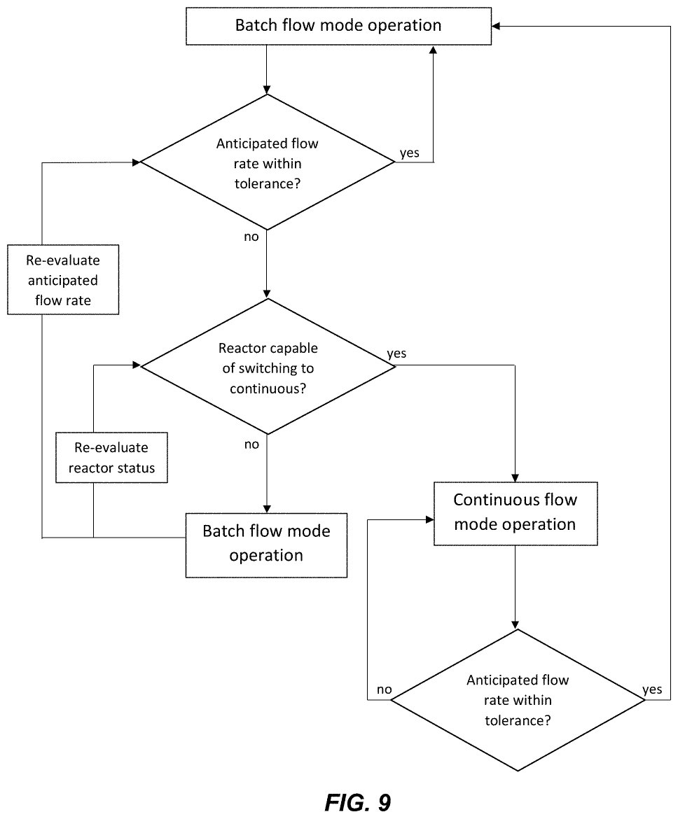

FIG. 9 is flowchart showing of a control scheme which can be implemented by controller 82. As shown in FIG. 9, the wastewater treatment ordinarily operates in a batch flow mode. The controller 82 may consider input signals to determine whether an anticipated flow rate is within tolerance of the hydraulic loading rate of the reactors. The controller may consider flow rate parameters selected from expected precipitation, actual precipitation, expected sewerage flow rate, and actual sewerage flow rate to determine the anticipated flow rate. If the anticipated flow rate is within tolerance, the system continues operation in the batch flow mode.

If the controller 82 determines the anticipated flow rate is greater than a tolerance of the reactor, the controller 82 may transmit an output signal to one or more reactor. The controller 82 may consider whether each reactor independently is in a state capable of receiving wastewater in a continuous flow mode. To determine the state of the reactor, the controller 82 may receive at least one input signal selected from available fill volume, influent water composition, process water composition, and hydraulic loading rate of the reactor. The controller 82 may additionally or alternatively consider the current cycle period of the reactor and/or the time remaining for the current cycle period. The controller 82 may additionally consider the type of cycle, for example, fixed time cycle or variable time cycle.

If the controller 82 determines the reactor is in a state capable of receiving wastewater in the continuous flow mode, the controller 82 may transmit an output signal instructing the reactor to transition to the continuous flow mode. If the controller 82 determines the reactor is not in a state capable of receiving wastewater in the continuous flow mode the controller 82 may wait a period of time and re-evaluate the reactor. The controller 82 may generally make the determination for each reactor independently and transition each reactor independently. Additionally, the controller 82 may periodically re-evaluate the anticipated flow rate. If the re-evaluated anticipated flow rate falls within tolerance of the reactor, the reactor may continue to operate in batch flow mode.

Once the reactor is operating in the continuous flow mode, the controller 82 may periodically re-evaluate the anticipated flow rate, as previously described. If the anticipated flow rate falls within tolerance, the controller 82 may transition the reactor to batch flow mode. In accordance with certain embodiments, if the anticipated flow rate falls within tolerance, the controller 82 may evaluate each reactor independently to determine if the reactor is in a state capable of receiving wastewater in the batch flow mode and transition each reactor independently, as previously described. If the anticipated flow rate is greater than the tolerance, the controller 82 may continue to operate the system in the continuous flow mode.

Each re-evaluation of the anticipated flow rate may be performed after a period of time, for example, a predetermined period of time or a period of time selected responsive to a determined parameter. For instance, the re-evaluation may occur on a timed schedule, such as every 6 hours, every 12 hours, every 24 hours, every 48 hours, or more. In other embodiments, the re-evaluation may occur responsive to a determined parameter, such as an expected precipitation or sewerage event or an actual precipitation or sewerage event. In some embodiments, each re-evaluation may occur on a timed schedule with additional re-evaluations performed responsive to any triggering parameter being detected.

When operating in any flow mode, the systems and methods disclosed herein may employ fixed time cycles or variable time cycles. Fixed time cycles typically run independent of reactor fill level. For instance, a full operating time may be used in times of low influent flow rate. Variable time cycles typically run in correspondence with reactor fill level. In such embodiments, cycle operating time may be modified to correspond with the fill volume. For instance, in times of low influent flow rate, one or more operating cycles may run for a fraction of the time, corresponding to the influent flow rate and/or fill volume. In certain embodiments, the amount of aeration may similarly be modified to correspond with the a predetermined dissolved oxygen concentration at that fill volume. In accordance with one exemplary embodiment, the batch flow mode and transition period may operate according to a variable time cycle and the continuous flow mode may operate according to a fixed time cycle. The controller may be configured to receive at least one input signal for the influent flow rate and/or fill volume and transmit an output signal for the cycle operating time.

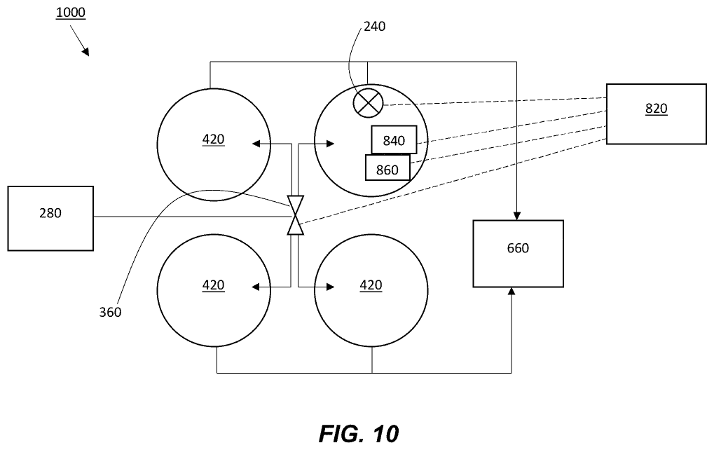

Thus, in accordance with certain embodiments, systems for treatment of wastewater are disclosed herein. Exemplary system 1000 is shown in FIG. 10. Exemplary system 1000 includes a plurality of sequencing batch reactors 420 connected to a source of wastewater to be treated 280 through loading subsystem 360 and connected to a treated water reservoir 660. Each sequencing batch reactor 420 comprises an aerator 240 connected to a source of an oxygen containing gas (not shown in FIG. 10). Each sequencing batch reactor may comprise a sensor associated with a sensing subsystem 860 for measuring a parameter of the mixed liquor and a sensor associated with a measuring subsystem 840 for determining a state of the reactor 420. It is noted that in FIG. 10, aerator 240 and sensors 860 and 840 are only shown in one reactor 420 for simplicity. However, each reactor 420 may generally include these components.

System 1000 includes controller 820 operably connected to the loading subsystem 360, aerator 240, sensing subsystem 860 and measuring subsystem 840. Controller 820 is configured to operate the system in a batch flow mode or continuous flow mode by controlling influent wastewater through the loading subsystem 360 and aeration through the aerator 240, optionally responsive to measurements obtained from one or more of the sensing subsystem 860 and the measuring subsystem 840. In some embodiments, controller 820 may also control a decant rate of the treated water to the reservoir 660. It is noted that in FIG. 10, a single controller 820 is shown in system 1000. However, the system 1000 may comprise multiple controllers, for example, a first controller configured to operate the system through loading subsystem 360 and a second controller configured to control aeration through aerator 240. Thus, controller 820 may be a single controller or a plurality of controllers.

Methods disclosed herein may additionally comprise providing one or more component of the system and, optionally, interconnecting the components to be operable as previously described. In accordance with certain embodiments, methods of retrofitting an existing wastewater treatment system may comprise providing a controller to operate the wastewater treatment system as disclosed herein. Methods of retrofitting may additionally comprise providing a component of the measuring subsystem and operably connecting the component to the controller. In some embodiments, methods of retrofitting may comprise providing a component to reduce or prevent backflow from one or more reactor while operating in the continuous flow mode. For instance, methods of retrofitting may comprise providing and/or installing one or more of a check valve, flow control valve, flow meter, inlet pump, distribution system, header, flow splitter, and/or inlet baffle configured to reduce or prevent backflow as previously described.

Methods of facilitating treatment of wastewater may additionally comprise providing the wastewater treatment system. In certain embodiments, the methods may comprise instructing a user to operate the wastewater treatment system to treat wastewater, as previously described.

Methods of controlling wastewater treatment may comprise introducing wastewater into a wastewater treatment system. The methods may comprise analyzing an operating condition for each of the reactors and transmitting a plurality of input signals, each corresponding to an operating condition of the plurality of the reactors. The methods may further comprise determining an anticipated flow rate and transmitting an input signal corresponding to the anticipated flow rate. The methods may comprise analyzing the plurality of input signals corresponding to the reactor operating conditions and the input signal corresponding to the anticipated flow rate. The methods may further comprise providing an output signal corresponding to one of a batch flow mode and a continuous flow mode responsive to the analysis of the input signals. The methods may comprise transitioning one or more reactor to an alternate mode responsive to the output signal.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of treating wastewater with a sequencing batch reactor system having a plurality of reactors arranged in parallel, comprising:
operating each of the reactors in a batch flow mode comprising introducing a wastewater to be treated into one reactor to produce a first mixed liquor and controlling a dissolved oxygen concentration of the first mixed liquor to a predetermined concentration insufficient to meet a biological oxygen demand of the wastewater to be treated, but sufficient to cause simultaneous nitrification and denitrification reactions to occur in the first mixed liquor, producing a first treated water and a first solids;
determining an anticipated flow rate of the wastewater to be treated at an inlet of the sequencing batch reactor system;
selecting one or more reactor as being in a state capable of receiving the wastewater to be treated in a continuous flow mode; and
responsive to the anticipated flow rate having been determined to be greater than a flow rate tolerated by a design hydraulic loading rate of each of the reactors, operating the one or more selected reactor in the continuous flow mode comprising simultaneously introducing the wastewater to be treated into the one or more selected reactor to produce a second mixed liquor, aerating the second mixed liquor to produce a second treated water and a second solids, settling the second solids, and decanting the second treated water.

2. The method of claim 1, wherein the batch flow mode further comprises sequentially settling the first solids and decanting the first treated water.

3. The method of claim 2, wherein the batch flow mode comprises a first treatment regime comprising controlling the dissolved oxygen concentration to a first predetermined concentration, a second treatment regime comprising controlling the dissolved oxygen concentration to a second predetermined concentration performed immediately following the first treatment regime, and a third treatment regime comprising controlling the dissolved oxygen concentration to a third predetermined concentration performed immediately following the second treatment regime,
the first predetermined concentration and the second predetermined concentration being insufficient to meet the biological oxygen demand of the wastewater to be treated, but sufficient to cause simultaneous nitrification and denitrification reactions to occur in the first mixed liquor and the third predetermined concentration being sufficient to meet the biological oxygen demand of the wastewater to be treated.

4. The method of claim 3, comprising selecting the one or more reactor based on a current cycle period being one of the first treatment regime, the second treatment regime, decanting, and idle.

5. The method of claim 1, wherein the continuous flow mode is associated with a hydraulic loading rate of about 25% to about 50% of a hydraulic loading rate associated with the batch flow mode.

6. The method of claim 1, further comprising measuring at least one reactor parameter for each of the reactors selected from available fill volume, composition of the wastewater to be treated, composition of the first mixed liquor, and hydraulic loading rate.

7. The method of claim 6, comprising selecting the one or more reactor responsive to the at least one measured reactor parameter.

8. The method of claim 1, further comprising determining at least one flow rate parameter selected from expected precipitation, actual precipitation, expected sewerage flow rate, and actual sewerage flow rate.

9. The method of claim 8, comprising determining the anticipated flow rate responsive to the at least one flow rate parameter.

10. The method of claim 8, wherein the expected precipitation or the expected sewerage flow rate is determined responsive to at least one of a predicted weather event, time of day, time of year, and geographic location.

11. The method of claim 1, wherein responsive to the anticipated flow rate having been determined to be within a flow rate tolerated by a design hydraulic loading rate of each of the reactors, continuing operation of the one or more selected reactor in the batch flow mode, and re-evaluating the anticipated flow rate of the wastewater to be treated at the inlet of the sequencing batch reactor system after a period of time.

12. The method of claim 1, further comprising measuring at least one of dissolved oxygen, oxidation reduction potential, and concentration of a nitrogen compound selected from molecular nitrogen (dinitrogen, N₂) gas, nitrate, nitrite, and/or ammonia of the first mixed liquor or the second mixed liquor.

13. The method of claim 12, wherein the predetermined concentration of dissolved oxygen is between about 0.05 mg/L and about 0.8 mg/L.

14. The method of claim 1, after operating the one or more reactor in the continuous flow mode, the method further comprising:
determining a subsequent anticipated flow rate of the wastewater to be treated at the inlet of the sequencing batch reactor system; and
responsive to the subsequent anticipated flow rate having been determined to be within the flow rate tolerated by the design hydraulic loading rate of each of the reactors, operating the one or more selected reactor in the batch flow mode.

15. The method of claim 1, further comprising a transition period comprising settling an effective amount of the solids at an outset of the continuous flow mode.

16. The method of claim 15, wherein the anticipated flow rate is a flow rate expected after an amount of time of the transition period.

17. A sequencing batch reactor system comprising:
a plurality of sequencing batch reactors arranged in parallel, each of the reactors having an inlet fluidly connectable to a source of wastewater to be treated and an outlet;
each of the reactors comprising an aerator configured to deliver an oxygen-containing gas to a mixed liquor within a corresponding reactor;
a loading subsystem configured to independently control a hydraulic loading rate of the wastewater to be treated into each of the reactors through the inlet; and
a controller operably connected to the aerator of each of the reactors and the loading subsystem, the controller configured to:
transmit a first output signal to the aerator of each of the reactors to control the dissolved oxygen concentration of the mixed liquor within the reactor to a predetermined concentration insufficient to meet a biological oxygen demand of the wastewater to be treated, but sufficient to cause simultaneous nitrification and denitrification reactions to occur in the mixed liquor, producing a treated water and a solids; and
transmit a second output signal to the loading subsystem to introduce the wastewater to be treated into one or more reactors in a continuous flow mode, responsive to the one or more reactor being in a state capable of receiving the wastewater to be treated in the continuous flow mode, and determining an anticipated flow rate of the wastewater to be treated at an inlet of the sequencing batch reactor system to be greater than a flow rate tolerated by a design hydraulic loading rate of each of the reactors.

18. The sequencing batch reactor system of claim 17, further comprising a sensing subsystem operably connected to the controller and configured to measure at least one parameter associated with a concentration of dissolved oxygen in at least one of the mixed liquor within each of the reactors and the wastewater to be treated and transmit a first input signal to the controller corresponding to the measured dissolved oxygen parameter.

19. The sequencing batch reactor system of claim 18, wherein the controller is configured to transmit the first output signal responsive to the first input signal.

20. The sequencing batch reactor system of claim 18, wherein the sensing subsystem is configured to measure at least one of dissolved oxygen concentration, oxidation reduction potential, and concentration of a nitrogen compound selected from molecular nitrogen (dinitrogen, N₂) gas, nitrate, nitrite, and/or ammonia of the mixed liquor and/or the wastewater to be treated.

21. The sequencing batch reactor system of claim 17, further comprising a measuring subsystem operably connected to the controller and configured to measure at least one parameter associated with the state of each of the reactors and transmit a second input signal to the controller corresponding to the at least one measured reactor parameter.

22. The sequencing batch reactor system of claim 21, wherein the controller is configured to transmit the second output signal responsive to the second input signal.

23. The sequencing batch reactor system of claim 22, wherein the measuring subsystem is configured to measure at least one of available fill volume, composition of the wastewater to be treated, composition of the mixed liquor, and hydraulic loading rate of each of the reactors.

24. The sequencing batch reactor system of claim 17, wherein the controller is configured to receive a third input signal corresponding to at least one anticipated flow rate parameter selected from expected precipitation, actual precipitation, expected sewerage flow rate, and actual sewerage flow rate and transmit the second output signal responsive to the third input signal.

25. The sequencing batch reactor system of claim 24, wherein the controller is programmable to recognize trends of the anticipated flow rate on a schedule and transmit the second output signal responsive to the recognized trends.
